(19) United States
(12) Patent Application Publication
(10) Pub. No.: US 2004/0037929 A1
(43) Pub. Date: Feb. 26, 2004

(54) Food preparation apparatus

(76) Inventor: Steven E. Williams, Germantown, MD (US)

Correspondence Address: LIEBERMAN & BRANDSDORFER, LLC, 12221 MCDONALD CHAPEL DRIVE, GAITHERSBURG, MD, 20878, US

(21) Appl. No.: 10/151,964

(22) Filed: May 22, 2002

(51) Int. Cl. A23B 4/00

(52) U.S. Cl. 426/112

(57) ABSTRACT

A method and apparatus for safely preparing food items is provided. A food item is placed in a container with an open top. The container holds a secondary receptacle with a lucid substance therein. A covering is placed over the top of the container to hold both the food item and secondary receptacle within the walls of the container. Prior to breaking the seal of the top covering, or in the process of breaking the seal of the top covering, the secondary receptacle may be pierced. Breaking the seal of the secondary receptacle forces the contents stored therein to exit the secondary receptacle and to come in contact with the food item stored in the container. The process of breaking the seal of the secondary container enables the food item in the container to be marinated without subjecting the food item to unnecessary handling or external sources of contamination.

### BACKGROUND OF THE INVENTION

1. Technical Field

This invention relates to a method and apparatus for preparing foods. More specifically, the method and apparatus enables preparation of food items in a safe manner for both the preparer and the recipient of the food item.

2. Description of the Prior Art

The process of preparing a meal for family and friends requires planning and careful food preparation. If the food is not properly handled in the preparation stage, the end food product can be hazardous and illness can arise in those eating the prepared foods. Cooks, whether professional or recreational, often need to review their food preparation practices, and inspect and clean the food preparation environment to maximize the likelihood that the food they prepare is safe for consumption. Regularly checking key critical control points in food preparation, such as proper cooking, cooling, reheating leftovers, and identifying and controlling points of contamination when preparing food will reduce the risk of food borne illness. This process is also known as Hazard Analysis Critical Control Points (“HACCP”). HACCP is used in food processing plants to reduce pathogens on meat, poultry and seafood products. Although foods that are prepared using the HACCP process are not sterile, the HACCP process enhances the safety of the foods and reduces risks associated with improper handling of food.

Potential hazards associated with food preparation in household, food service, food processing, and food preparation locales include biological, chemical and physical hazards. Biological hazards are hazards associated with food borne bacteria. Effects of food borne bacteria in improperly prepared foods can lead to illness if the food is mishandled. In general, young children, elderly and ill people are at the highest risk of suffering from such bacteria. Certain processes of handling practices by consumers and foodservice workers both in the home and in the commercial kitchen have been identified as being essential or critical in preventing food borne illness. These practices, which prevent or control the microbial contamination associated with food borne illness, are under the direct control of the consumer and foodservice workers, from food acquisition through disposal. Such practices include proper purchasing of the food, storing, pre-preparation, cooking, serving and handling of leftover foods. Accordingly, failure to take appropriate action at any of the above listed stages could result in food borne illness resulting from the food served.

Food preparation is a critical step in the process of producing a safe and healthy food product. However, there also are several steps involved in the pre-preparation of food. One step is the process of having the food preparer properly wash there hands. This is a simple practice that aids in preventing food contamination or cross-contamination, but is frequently not properly practiced by those who handle food. Hand washing should be conducted before beginning food preparation, as well as subsequent to handling raw meats, or at any time in the process of preparation when the food handlers hands may have been exposed to a source of contamination. Not only should the food handler's hands be properly cleaned, it is also critical that the counter, and all food equipment be properly cleaned prior to use and that they be cleaned immediately following use as well. In addition, the food handler should make sure that juices from raw meat, poultry or seafood do not come into contact with cooked foods or foods that are commonly eaten in a raw form, such as fruits and salads. As for the food product, all foods that require thawing should be thawed in a refrigerated environment and not on a counter surface at room temperature. Alternatively, the food product can be thawed in a microwave, or alternative method of rapid thawing, just prior to cooking. Finally, food that is intended to be marinated subsequent to any required thawing process and prior to cooking should be marinated in the refrigerator and not on a counter or open surface. The marinate sauce should not be used on cooked food unless it is boiled prior to use. Accordingly, following the basic principles of time and temperature control, with the use of barriers to cross-contamination, will help minimize the occurrence of food borne illness.

In view of the hazards associated with food preparation, and specifically in thawing meats and poultry and marinating the food items prior to cooking, it is desirable to utilize a product that mitigates such known hazards. Accordingly, there is a need for a product and a process that marinates the food items while mitigating exposure to outside food borne bacteria, as well as a product and process that guards against exposing other food items in the kitchen work area from bacteria inherent to raw meat, poultry and seafood while being prepared.

### SUMMARY OF THE INVENTION

This invention comprises a product and process for marinating pre-packaged food items.

In a first aspect of the invention, a container for packaged food product is provided. The container includes a first compartment defined by a bottom wall and side walls. Opposite to the bottom wall is an open portion. The food content is positioned between the side walls, and a bladder is also positioned between the side walls. The container may be modified to include multiple bladders. A seal is used to enclosed the open portion and to maintain the food content and bladder within the container. The food content may be positioned adjacent to a top surface of the bottom wall. Alternatively, the food content may be positioned adjacent to a top surface of the bladder. The bladder may be positioned adjacent to a top surface of the bottom wall. Alternatively, the bladder may be positioned adjacent to a top surface of the bladder. In addition to positioning of the food content and bladder, the container may include an element adapted to pierce through the bladder. The piercing element may be positioned on an interior surface of one of the side walls, and may be in a form selected from the following group: a pincer with a spring loaded safety cap, a clip with a safety cap, and a spring clip with a safety cap. In addition, the bladder may be fixed within the container, or it may be removable from the container.

In a second aspect of the invention, a method for marinating food content is provided. A sealed bladder is placed within a container. In addition, a food item is placed within the container adjacent to the bladder. A seal is placed over a top portion of the container to hold the food and bladder within the container. The bladder is pierced to enable liquid contents held within the bladder to be expelled from the bladder into the container. The step of piercing the bladder may include placing an external element into contact with the bladder through the seal. Alternatively, the step of piercing the bladder may include placing an element internal to the container into contact with the bladder.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a perspective view of a food holding receptacle according to the preferred embodiment of this invention, and is suggested for printing on the first page of the issued patent.

FIG. 2 is a perspective view of a food holding receptacle with the contents of a secondary receptacle.

FIG. 2a is a side view of the food handling receptacle taken along line A of FIG. 1.

FIG. 3 is a side view of an internal clip piercing element.

FIG. 4 is a side view of an internal spring based piercing element.

FIG. 5 is a side view of an internal pincer apparatus.

### DESCRIPTION OF THE PREFERRED EMBODIMENT

### Overview

Proper preparation of food items requires careful planning and preparation to avoid preparing foods that may be potentially harmful to the intended recipients. One important component when preparing meats, poultry and/or seafood items is to thaw the food items properly if the items are frozen. A popular step in preparing food items is to marinate the foods for a set period of time prior to cooking. Often the marination process can be messy and cumbersome, and may be challenging for both experienced and inexperienced cooks alike. Accordingly, it is desirable to provide an arrangement that alleviates any difficulties associated with food marination from selecting a flavor for a desired affect, as well as an efficient product and process for marinating foods that maintains the safety elements associated with food preparation.

### Technical Background

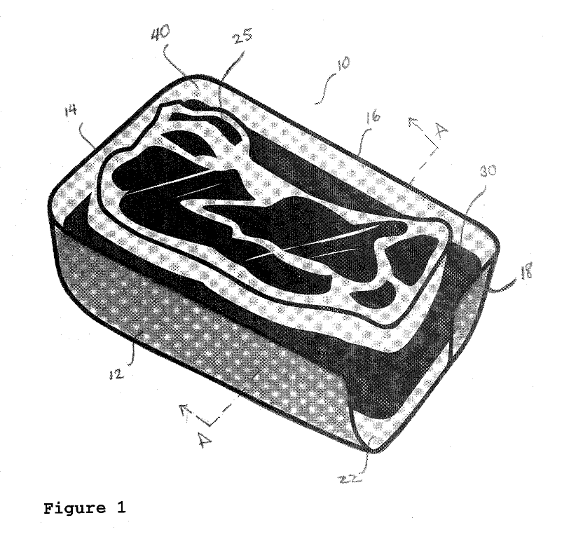

FIG. 1 is a perspective view of a primary receptacle 10 adapted to hold a food item 25 within the walls 12, 14, 16 and 18 of the primary receptacle 10. In addition to the food item 25, the primary receptacle 10 includes a secondary receptacle 30 that preferably contains a liquid or comparable lucid substance. The secondary receptacle 30 is sealed, and is independent of the primary receptacle 10. The primary receptacle 10 has a bottom wall 22, and side walls 12, 14, 16 and 18. Each of the side walls extend their full length so that adjacent walls meet at their respective comers. A top portion of the primary receptacle 10 is open. When the contents that are intended to be placed in the primary receptacle 10 have been properly placed and positioned within the walls 12, 14, 16 and 18 thereof, the primary receptacle 10 may be sealed with a covering 40. Accordingly, the primary receptacle 10 has a bottom wall 22 and side walls 12, 14, 16 and 18 and is adapted to receive a covering 40 over the top portion to enclose whatever contents are intended to be placed within the primary receptacle 10.

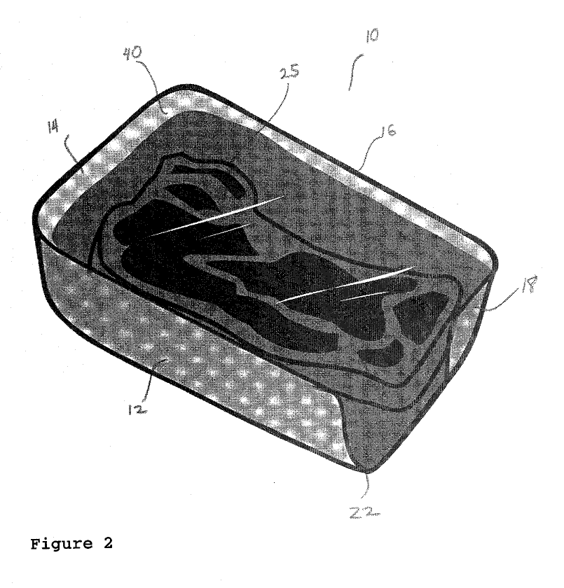

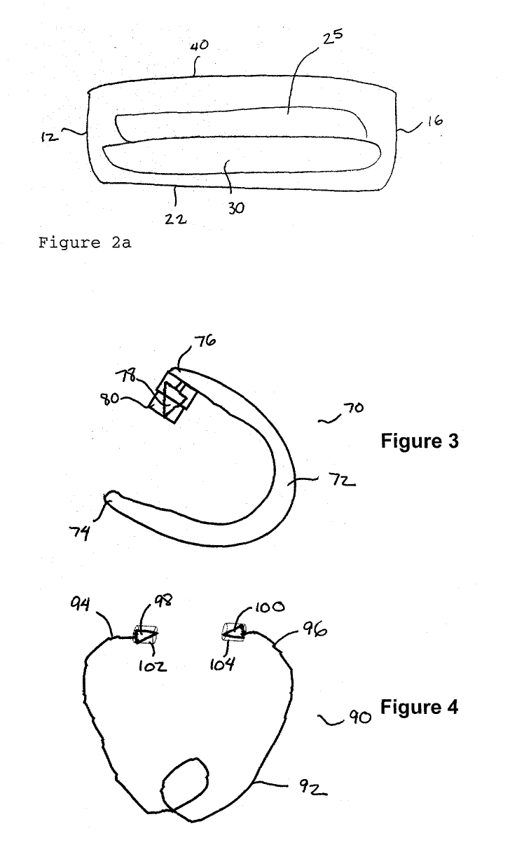

The primary receptacle 10 in a static state will contain the food item 25 adjacent to a secondary receptacle 30, or multiple secondary receptacles. In order to change the phase and function of the primary receptacle 10 and the food item 25 therein, a person handling the primary receptacle 10 must form an opening in the secondary receptacle 30. FIG. 2 is an illustration of one embodiment demonstrating how the lucid contents of the secondary receptacle 30 may exit therefrom. A person handling the primary receptacle 10 may place the primary receptacle 10 on a flat surface, and thereafter place a sharp object through the covering 40 and into the seal of the secondary receptacle 30. Once the secondary receptacle 30 has been pierced, an aperture will have been formed for the contents of the secondary receptacle to exit therefrom. In a preferred embodiment, the sharp object will have pierced through a bottom surface of the secondary receptacle 30 to enable the contents to exit therefrom through the force of gravity. If the food item 25 in this embodiment is placed adjacent to the bottom surface of the secondary receptacle 30, the contents of the secondary receptacle 30 will flow directly into the food item 25. FIG. 2a is a side view of the receptacle of FIG. 1 taken along line A-A. This figure shows the placement of the food item 25 relative to the secondary receptacle 30, together with the covering 40 placed over the primary receptacle. Accordingly, the embodiment illustrated in FIGS. 2 and 2a show one embodiment which requires piercing of the secondary receptacle 30 as well as the covering 40 to allow the contents of the secondary receptacle 30 to exit therefrom.

One limitation associated with the embodiment illustrated in FIGS. 1 and 2 is the requirement of breaking the covering 40 in addition to the seal of the secondary receptacle 30. In some environments it may be desirable to maintain the covering 40 of the primary receptacle 10 while breaking the seal of the secondary receptacle 30. This would enable the food item 25 to be exposed to the contents of the secondary receptacle 30 while preserving the contents of the primary receptacle 30 in a sealed container. FIG. 3 is a side view of a clip 70 that enables maintaining the contents of the primary receptacle 10 within a cohesive seal of the covering 40. In a preferred embodiment, the clip 70 is placed in the primary receptacle 10 prior to placement of the covering 40 over the contents within the primary receptacle 10. The clip 70 includes an elongated stem 72 with a proximal end 74 and a distal end 76. The proximal end 74 of the stem 72 is secured to a wall of the primary receptacle 10. The distal end 76 of the stem 72 is placed adjacent to the secondary receptacle 30 when the clip 70 is secured in the primary receptacle 10. The distal end 76 of the stem 72 includes a piercing element 78 enveloped by a safety cap 80. In a stationary position, the piercing element 78 remains enclosed by cap 80 and does not subject the secondary receptacle 30 to piercing by a sharp object. However, at such time as pressure is exerted on the distal end 76 of the stem 72, the piercing element 78 is pushed out of the safety cap 80 and breaks through the material of the secondary receptacle 30. Accordingly, the elongated stem 72 in combination with the safety cap 80 and piercing element 78 provides an embodiment that enables piercing of the secondary receptacle 30 without breaking the seal of the covering 40 of the primary receptacle 10.

The elongated stem 72 of FIG. 3 may be placed in a plurality of locations within the walls of the primary receptacle 10. In a preferred embodiment, the stem 72 is placed along a corner where two of the walls of the primary receptacle 10 meet. The stem 72 includes a proximal end 74 and a distal end 76. The distal end 76 is fixed to one wall of the primary receptacle 10, and the proximal end 74 is fixed to a second wall of the primary receptacle 10. The safety cap 80 and piercing element 78 are located at the proximal end 74. A person who would like to have the contents of the secondary receptacle 30 enter the primary receptacle 10 must exert pressure on the two walls of the primary receptacle 10 to which the proximal and distal ends 74 and 76, respectively, are fixed. When the piercing element 78 is adjacent to the secondary receptacle 30 and the pressure exerted on the secondary receptacle 30 exceeds the threshold defined by the material enclosing the secondary receptacle 30, an opening in the secondary receptacle 30 will occur. Thereafter, the contents of the secondary receptacle 30 will begin exiting the secondary receptacle 30 and entering the primary receptacle 10. This process enables the contents 25 of the primary receptacle 10 to be exposed to the contents of the secondary receptacle 30. In addition, since the piercing element 78 is internal to the primary receptacle 10, the top covering 40 of the primary receptacle 10 remains intact, thereby preventing the fluid in the primary and secondary receptacles 10 and 30, respectively, from exiting the primary receptacle 10 or otherwise being exposed to the atmosphere. Accordingly, the piercing element 78 enables the contents of the primary and secondary receptacles 10 and 30, respectively, to remain isolated from exposure to potential contaminants.

FIG. 4 is a side view of a spring element 90 for piercing the secondary receptacle 30 without piercing or otherwise opening the top covering 40 of the primary receptacle 10. As shown in FIG. 4, the spring element 90 includes an elongated stem 92 with a proximal end 94 and a distal end 96. Both ends 94 and 96 include piercing elements 98 and 100, respectively. Each of the piercing elements 98 and 100 are enclosed with a covering 102, 104, respectively, to prevent the piercing elements 98 and 100 from accidentally creating an opening in either the secondary receptacle 30 or the top covering 40 of the primary receptacle 10. The covering 102, 104 of the piercing elements 98, 100 prevent the piercing elements 98, 100 from exposure to the secondary receptacle 30, the top covering 40, the walls of the primary receptacle 10, and any other elements sensitive to piercing from sharp objects. The stem 92 is preferable secured to a wall of the primary receptacle 10, so as to enable the stem 92 to be fixed to a stationary object. A person who would like to have the contents of the secondary receptacle 30 enter the primary receptacle 10 must exert pressure on both the proximal and distal ends 94 and 96, respectively, of the spring element 90. Pressure on the piercing elements 98 and 100 may also occur through exerting pressure on the walls of the primary receptacle 10 to which the stem 92 is fixed. When the piercing elements 98 and 100 are adjacent to the secondary receptacle 30 and the pressure exerted on the secondary receptacle 30 exceeds a piercing threshold, the piercing element 98, 100 extends beyond the limit of the respective covering 102 and 104. The piercing element 98, 100 creates an opening in the material enclosing the secondary receptacle 30. Thereafter, the contents of the secondary receptacle 30 will begin exiting the secondary receptacle 30 and entering the primary receptacle 10. This process enables the contents of the primary receptacle 10 to be exposed to the contents of the secondary receptacle 30. In addition, since the piercing element 98, 100 is housed withing the primary receptacle 10, the top covering 40 of the primary receptacle 10 remains intact, thereby preventing the fluid in the primary and secondary receptacles 10 and 30, respectively, from exiting the primary receptacle 10 or otherwise being exposed to the atmosphere. Accordingly, the piercing elements 98 and 100 enable the contents of the primary and secondary receptacles 10 and 30, respectively, to remain isolated from exposure to potential contaminants external to the primary receptacle 10.

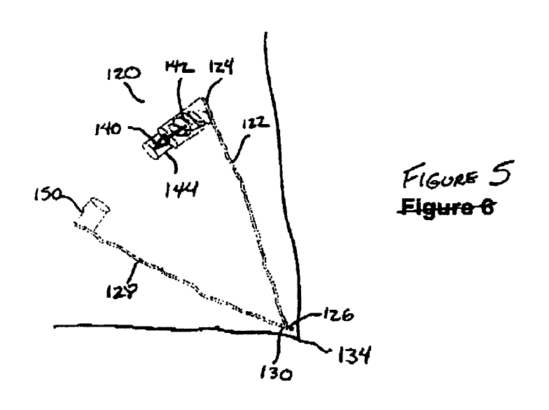

FIG. 5 is a side view pincer apparatus 120 for piercing the secondary receptacle 30 without piercing or otherwise opening the top covering 40 of the primary receptacle 10. As shown in FIG. 5, the pincer apparatus 120 includes a primary stem 122 and a secondary stem 128. The primary stem 122 includes a proximal end 124 and a distal end 126. The distal end 126 of the primary stem 122 is secured to a distal end 130 of the secondary stem 128, and a corner 134 of the primary receptacle 10. Similarly, the distal end 130 of the secondary stem 128 is secured to a distal end 126 of the primary stem 122 and a corner 134 of the primary receptacle 10. The proximal end 124 of the primary stem 122 includes a piercing element 140 secured to the proximal end 124 by means of a spring 142. In a rest position, the tension in the spring 142 maintains the piercing element 140 within the confines of a receiving cap 144, and prevents the piercing element 140 from accidentally creating an opening in either the secondary receptacle 30 or the top covering 40 of the primary receptacle 10. The secondary stem 128 includes a receiving cap 150 at a proximal end thereof. The receiving cap 150 is a hollow and circular shaped element although alternative shaped elements may be used. The circumference of the enclosing cap 150 of the secondary stem 128 is greater than the circumference of the receiving cap 144 of the primary stem 122. Accordingly, this enables the receiving cap 144 of the primary stem 122 to receive the enclosing cap 150 of the secondary stem.

A person who would like to have the contents of the secondary receptacle enter the primary receptacle must exert sufficient pressure on the piercing element 140 to exceed the tension in the spring 142 holding the piercing element 140 within the receiving cap 144. Pressure on the piercing element 140 may also occur through exerting pressure on the walls of the primary receptacle 10 to which the primary and secondary stems 122 and 128, respectively, are fixed. When the piercing element 140 is adjacent to the secondary receptacle 30 and the pressure exerted on the secondary receptacle 30 exceeds the threshold defined by tension in the spring 142, the piercing element 140 extends beyond the limit of the receiving cap 144. The piercing element 140 places an opening in the material enclosing the secondary receptacle 30. Thereafter, the contents of the secondary receptacle 30 will begin exiting the secondary receptacle 30 and entering the primary receptacle 10. This process enables the contents of the primary receptacle 10 to be exposed to the contents of the secondary receptacle 30. In addition, since the piercing element 140 is internal to the primary receptacle 10, the top covering 40 of the primary receptacle 10 remains intact, thereby preventing the fluid in the primary and secondary receptacles 10 and 30, respectively, from exiting the primary receptacle 10 or otherwise being exposed to the atmosphere. Accordingly, the piercing element 140 enables the contents of the primary and secondary receptacles 10 and 30, respectively, to remain isolated from exposure to potential contaminants external to the primary receptacle 10.

### Advantages Over The Prior Art

The structure of the food storage apparatus together with the means for piercing the secondary receptacle provides a clean and safe manner in which food items can be marinated or otherwise prepared prior to cooking. It is common to marinate food items, or to otherwise subject food items to a preparative fluid prior to the cooking of the food item. The apparatus and method disclosed herein, enables a food preparer to subject a food item to a fluid without exposing a raw food item to human skin or to atmospheric conditions and limiting exposure of food items to potential contaminants. Concern for spilling of raw juices and cleanliness of associated raw food items are mitigated by maintaining the integrity of the apparatus.

### Alternative Embodiments

It will be appreciated that, although specific embodiments of the invention have been described herein for purposes of illustration, various modifications may be made without departing from the spirit and scope of the invention. In particular, alternative mechanisms may be placed within the container to enable a person to open the contents of the secondary receptacle without subjecting the primary receptacle to an opening. Additionally, the apparatus may contain multiple food items, as well as multiple secondary receptacles. Enlargement of the apparatus would also enable placement of additional elements for opening the secondary receptacles placed within the apparatus. Accordingly, the scope of protection of this invention is limited only by the following claims and their equivalents.

We claim:

1. A container for packaged food content comprising:
(a) a first compartment defined by a bottom wall and side walls, and having an open portion opposite said bottom wall;
(b) said food content positioned between said side walls;
(c) a bladder positioned between said side walls; and
(d) a seal to enclose said open portion.

2. The container of claim 1, wherein said food content is positioned adjacent to a top surface of said bottom wall.

3. The container of claim 1, wherein said food content is positioned adjacent to a top surface of said bladder.

4. The container of claim 1, wherein said bladder is positioned adjacent to a top surface of said bottom wall.

5. The container of claim 1, wherein said bladder is positioned adjacent to a top surface of said food content.

6. The container of claim 1, further comprising an element adapted to pierce through said bladder.

7. The container of claim 6, wherein said element is positioned on an interior surface of one of said side walls.

8. The container of claim 6, wherein said element is in a form selected from the group consisting of: a pincer with a spring loaded safety cap, a clip with a safety cap, and a spring clip with a safety cap, and combinations thereof.

9. The container of claim 1, wherein said container includes multiple bladders.

10. The container of claim 1, wherein said bladder is removable.

11. A method for marinating food content comprising:
(a) placing a sealed bladder within a container;
(b) placing a food item within said container adjacent to said bladder;
(c) placing a seal over a top portion of said container;
(d) piercing said bladder for enabling liquid contents held within said bladder to be expelled from said bladder into said container.

12. The method of claim 11, wherein the step of piercing said bladder includes placing an external element into contact with said bladder through said top seal.

13. The method of claim 11, wherein the step of piercing said bladder includes placing an element internal to said container into contact with said bladder.

14. The method of claim 13, further comprising the step of said top seal remaining stationary.

15. The method of claim 13, wherein said internal element is selected from the group consisting of: a pincer with a spring loaded safety cap, a clip with a safety cap, and a spring clip with a safety cap, and combinations thereof.

16. A container for packaged food content comprising:
(a) a first compartment defined by a bottom wall and side walls, and having an open portion opposite said bottom wall;
(b) said food content positioned within said container;
(c) a sealed bladder adapted to contain a lucid product positioned between said side walls;
(d) a seal to enclose said open portion; and
(e) an element positioned within said container and adapted to pierce said bladder.

17. The container of claim 16, wherein said element is in a form selected from the group consisting of: a pincer with a spring loaded safety cap, a clip with a safety cap, and a spring clip with a safety cap, and combinations thereof.
